(19) United States
(12) Patent Application Publication
(10) Pub. No.: US 2006/0087746 A1
(43) Pub. Date: Apr. 27, 2006

(54) Remote augmented motor-sensory interface for surgery

(76) Inventor: Kenneth Lipow, Fairfield, CT (US)

Correspondence Address: MCCORMICK, PAULDING & HUBER LLP, CITY PLACE II, 185 ASYLUM STREET, HARTFORD, CT, 06103, US

(21) Appl. No.: 11/255,899

(22) Filed: Oct. 20, 2005

Related U.S. Application Data
(60) Provisional application No. 60/621,541, filed on Oct. 22, 2004.

(51) Int. Cl. G02B 15/14

(52) U.S. Cl. 359/689

(57) ABSTRACT

A portable augmented motor-sensory interface (“PAMI”) system for “tele-controlled” surgery includes a PAMI tele-controller and a portable PAMI medical field unit positioned at a different, distant location and configured for wireless communications with the tele-controller. (“Tele-control” refers to electronically translating and/or transmitting a physician's actions over a long distance.) The field unit has a surgical module, including robotic effectors/arms, configured for carrying out medical procedures, and a video sensor boom for electronically viewing a wound site. The tele-controller has a user interface with input controls and a display that outputs sensory information relating to the patient and field unit. For treating a patient, the field unit is deployed next to the patient and a communications link is established to the tele-controller. A physician at the tele-controller receives sensory input from the field unit through the user interface display, and manipulates the input controls for tele-controlling the surgical module.

This application claims the benefit of U.S. Provisional Application Ser. No. 60/621,541, filed Oct. 22, 2004.

### FIELD OF THE INVENTION

The present invention relates to surgical devices and, more particularly, to remote electronic or robotic surgical instrument systems.

### BACKGROUND OF THE INVENTION

In emergency care situations, especially those involving life-threatening injuries, time is of the essence in stabilizing patients and transporting them to a suitable medical facility. However, in remote, isolated, potentially hostile locations, such as on a battlefield or in undeveloped areas, it may not be possible to easily or quickly transport a wounded soldier or other patient to a medical facility. If the patient is not given significant medical care within the first minutes to hour (the so-called “Golden Hour”) after the traumatic event and/or from going into shock, that patient's chances of survival are significantly reduced. Stopping blood loss, administering medications and IV fluids, and even emergency surgery, all are critical factors within the first hour after injury.

Because of limited forward military resources and the need to travel quickly and lightly, combat units will typically only have a minimal or moderate amount of on-hand medical support, usually in the form of a field medic and his or her portable medical equipment. FIG. 1 illustrates a timeline for critical medical care in a combat or similar situation involving such a combat unit. As a result of a traumatic event (e.g., combat injury), the patient may be suffering from internal tissue and organ damage, bleeding, broken bones, breathing trouble, shock, etc. Within the first five (5) minutes, a safety buddy aide (a fellow soldier or other person) assesses the situation and calls for medical help, along with administering first aid such as wound compression and CPR. Then, if possible within twenty (20) minutes of the traumatic event, the field medic arrives to administer additional, advanced first aid (apply medications and IV fluids, bandage wounds, etc.) in an attempt to stabilize the patient for transport or further treatment. Within the next several hours, but more preferably within the Golden Hour window, the patient is transported to a medical facility and receives advanced medical care, including surgery if needed.

Combat operations (involving ongoing hostilities and/or remote, inaccessible locations) tend to temporally and spatially separate location/time-dependent medical resources from the traumatic event and the Golden Hour period. In other words, the problems and challenges associated with emergency medical care generally (quick stabilization and transport to a medical facility) are exacerbated when combat and remote locations are involved, because soldiers and other personnel are less easily and quickly accessed. Thus, the typical combat unit has minimal on-hand medical support and medical resources, in terms of personnel, experience, and materials, during the period when critical care is most important. This applies to civilian emergencies as well.

To supplement the field medic's expertise in dealing with combat injuries, various automatic medical treatment systems have been proposed in the past. Usually, these devices replicate or mimic surgical operations or other medical procedures where surgeons are not available. This might include scanning the patient with various sensors, calculating a course of treatment, and then treating the patient according to the calculated course. While these devices have theoretical utility, current limits in computational power and computer programming mean that surgical robots and similar systems come nowhere near to replicating the experience and skill of a human medical doctor and/or trained medical professional. This is especially true in situations involving complications or unforeseen occurrences—while a human doctor can rely on experience, creative problem solving, and intuition, automated mechanical systems are restricted by their limited internal programming. In addition, these systems are extremely bulky and difficult to transport.

Accordingly, it is desirable to provide a system where medical resources (experience, skill, equipment, action) are time-shifted forwards closer to a traumatic combat event and space-shifted into the hostile combat or underserved non-combat environment in order to more rapidly and comprehensively treat combat/traumatic wounds and surgical diseases.

It is further desirable to provide a medical treatment system that utilizes, enhances, and augments human medical skill and experience in a light-weight, transportable package.

Additionally, it is desirable to provide such a system where medical preparedness and effectiveness can be enhanced through physiologically augmented training, education, and simulation.

### SUMMARY OF THE INVENTION

An embodiment of the present invention relates to a portable augmented motor-sensory interface (“PAMI”) system for “tele-controlled” manipulation of objects such as electronic and mechanical assemblies, explosive devices, and human beings, e.g., surgery. (By “tele-control,” it is meant electronically translating and/or transmitting a person's actions over a long distance, including possible augmentation.) The PAMI system includes a PAMI field unit and a tele-controller unit located at different, distant locations. The field unit and tele-controller are remotely connected to one another over a wireless communications link or the like. The field unit will typically be portable, and includes one or more electrically controlled manipulators (robotic effectors or arms) configured for manipulating objects, as well as at least one sensor array (such as a video sensor boom) configured for capturing a stereoscopic view and other sensory data of the object. The tele-controller includes an input control system, and a display for displaying the sensory data from the field unit.

In operation, the field unit and an object are brought into proximity to one another (e.g., the field unit is deployed next to the object) by a field technician or other personnel, and the field unit is set up to transmit sensory data of the object (including the positioning of the arms relative to the object) to the tele-controller for display. Based on the displayed sensory data, a person operating the tele-controller (an explosives expert, physician, etc.) manipulates the tele-controller's input controls for controlling the field unit. In particular, control signals are generated based on the manipulated input controls, which are transmitted to the field unit for moving the manipulators. At the same time, the field technician manually assists the field unit in carrying out its controlled manipulations of the object, under the direction of the tele-controller operator or otherwise. The field unit may be configured for providing tele-haptics feedback to the tele-controller, and the control signals from the tele-controller may be augmented for profiled manipulations of the object or the like.

According to an additional embodiment of the invention, the PAMI system may be used for tele-controlled surgery and other medical procedures. For surgery, the PAMI field unit will have a surgical module with one or more manipulators configured for carrying out surgical operations, and at least one sensor array configured for electronically viewing or otherwise sensing a patient and wound site. The tele-controller display will be configured for outputting detailed visual, auditory, tactile/tactual, and other sensory information relating to the patient and to the field unit. In operation, the PAMI field unit is carried in the field by a field medic or other medical technician, or other personnel. When someone is injured or otherwise requires medical attention, the field medic deploys the PAMI field unit next to the patient and a communications link is established to the tele-controller. Initial data relating to the patient's condition is relayed to the tele-controller, which is manned by a medical doctor or physician. The physician uses the initial data to diagnose the patient's condition and to determine the best course of action for treatment. Subsequently, the physician tele-controls the field unit by manipulating the tele-controller's input controls, for performing surgery or another medical procedure, based on the received sensory data. The physician's manipulations and/or movements are sensed and used by the tele-controller to generate a set of control signals that are subsequently transmitted over the communications link to the PAMI field unit for controlling movement of the surgical module. The physician may also direct the field medic in supplementing the functionally of the PAMI field unit and/or in assisting the field unit during operation.

In another embodiment, the control signals from the tele-controller to the field unit are augmented or modified for enhanced control of the surgical module. For example, the control signals may be augmented for profiled microsurgery, wherein a certain amount of movement by the physician is converted into a control signal that causes the surgery module's arms to move a proportionally and profiled smaller amount with custom motion parameter profiling modification. Another possible augmentation includes hand tremor scaling and modulation to improve surgeon performance.

According to an additional embodiment, a plurality of PAMI field units and tele-controllers are deployed, typically in different locations distant from one another. The tele-controllers may be interconnected to one another through a network, which is in turn configured for remote wireless communications with the field units. When a field unit is powered up for use in treating a patient, a link is established between the field unit and the network and one or more of the tele-controllers, with the initial patient data being transmitted to each of the tele-controllers. This enables a group of physicians, one at each tele-controller, and potentially located far away from one another, to reach a consensus diagnosis and course of treatment. Subsequently, one of the tele-controllers is designated for control of the field unit for its associated physician to perform a surgical operation. The physicians at the other tele-controllers may be provided with a parallel video feed for also monitoring the surgery or for backup purposes.

### BRIEF DESCRIPTION OF THE DRAWINGS

These and other features, aspects, and advantages of the present invention will become better understood with respect to the following description and accompanying drawings (not to scale), in which:

FIG. 1 is a schematic table showing a typical critical care timeline;

FIG. 2 is a schematic view of a remote portable augmented motor-sensory interface (“PAMI”) system for surgery according to the present invention;

FIG. 3 is schematic end elevation view of a PAMI medical field unit portion of the system in FIG. 2;

FIG. 4 is a schematic side elevation view of a PAMI medical field unit portion of the system in FIG. 2;

FIG. 5 is a schematic top plan view of the PAMI field unit of FIG. 2;

FIG. 6 is a perspective view of the PAMI field unit;

FIG. 7 is a schematic diagram of a communications/control module portion of the PAMI field unit of FIG. 6;

FIG. 8 is a schematic diagram of a tele-controller portion of the PAMI system in FIG. 2;

FIG. 9 is a schematic diagram of a surgery module portion of the PAMI field unit;

FIG. 10 is a schematic end elevation view of a patient restraint system according to one embodiment of the present invention; and

FIG. 11 is a schematic diagram of an additional embodiment of the PAMI system.

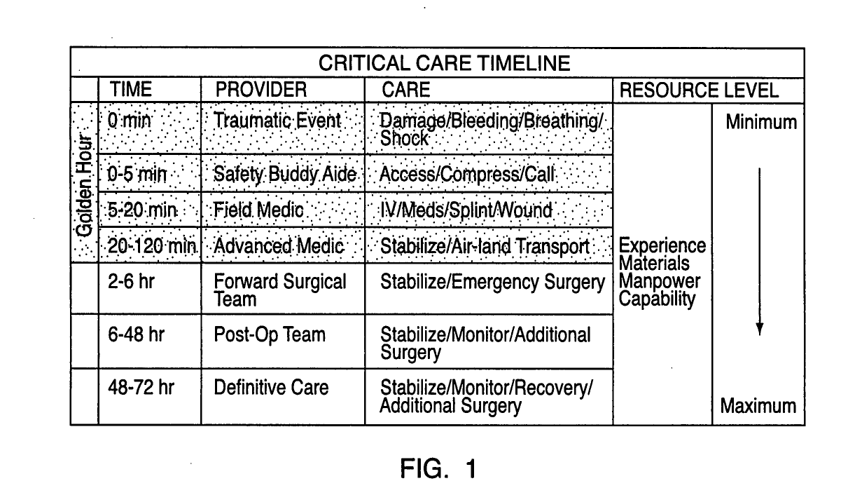

### DETAILED DESCRIPTION

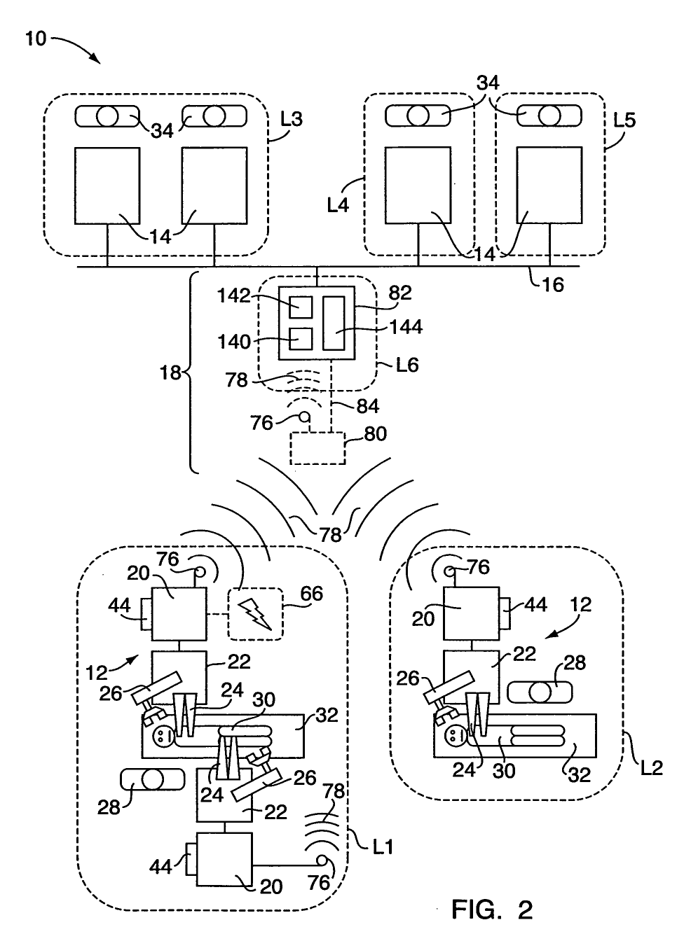

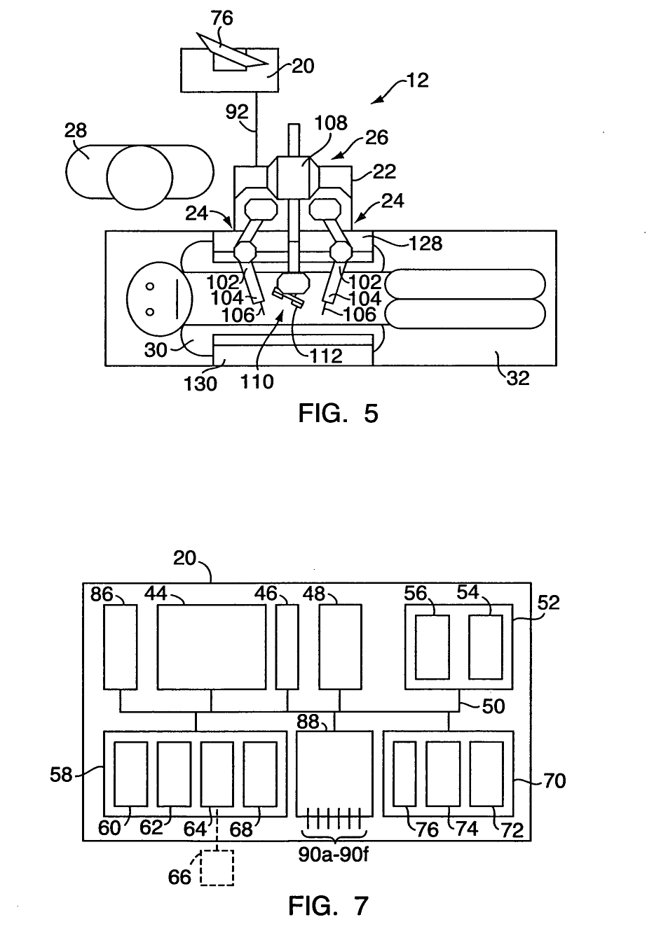

Referring to FIGS. 2-10, a portable augmented motor-sensory interface (“PAMI”) system 10 for tele-controlled object manipulation comprises at least one PAMI field unit 12 at one location and at least one PAMI tele-controller 14 at another, distant location. By “tele-control,” it is meant that an operator's actions, as inputted at the tele-controller 14, is electronically translated and/or transmitted (and possibly augmented) over a long distance for controlling the field unit 12. The PAMI system 10 may be used for manipulating objects such as mechanical and electrical assemblies and explosive devices, but will be primarily illustrated hereinafter with respect to an embodiment for carrying out surgery and other medical operations on human patients.

The tele-controller 14 and field unit 12 are configured for wirelessly communicating with one another over a long distance. If a plurality of PAMI tele-controller 14 is provided, the tele-controllers 14 may be remotely interconnected to form a trauma network 16, with the trauma network 16 being remotely connected to the PAMI field unit(s) 12 through a long-distance (i.e., local, intermediate, or potentially global) communications link or relay 18. Each PAMI field unit 12 is modular and/or portable (typically, there will be one field unit 12 per patient stretcher to travel with the patient) and includes a communications/control module 20 and a surgery or manipulation module 22. These two modules may be incorporated into one physical unit. The surgery module 22 has one or more robotic effectors or arms 24 and at least one sensor for generating sensory data of the patient, e.g., a video sensor boom 26. Although they would all be generally similar to one another in terms of overall function and purpose, different types of PAMI field units may be provided offering varying levels of sophistication and/or portability, for different situations. For example, one type of PAMI field unit might be very light and compact (e.g., weighing less than 30 pounds) for transporting in a single backpack. Another type, meant for transporting in a vehicle, might be heavier and offer more functionality. A third type might be even less easily portable, but offer greater functionality, for use in a remote field hospital or the like.

In operation, one or more field medics or other personnel 28 carry the PAMI field unit 12 during various military or combat operations. When a soldier or other person 30 is injured, the field medic 28 administers first aid as needed to stabilize the patient 30, and the patient is set on a stretcher 32 and/or a PAMI restraint platform and immobilized. The PAMI field unit 12 is then deployed on the spot, with the surgery module 22 being positioned next to the wound site and a communications link being established from the communications/control module 20 to the trauma network 16. A report or other initial data relating to the patient's condition (video of the wound site, audio, vital statistics, the field medic's report as to the cause of injury) is relayed to all the PAMI tele-controllers 14 (for example, simultaneously), which is then used by at least one medical doctor 34 to diagnose the patient's condition and determine the best course of action for treatment. Alternatively, data can be relayed directly to a single PAMI tele-controller.

Subsequently, one of the physicians 34 uses his or her local PAMI tele-controller 14 to tele-control the surgery module 22 for conducting surgery on the patient 30. In particular, through the PAMI tele-controller 14, the physician 34 is supplied with detailed visual, auditory, tactile/tactual, and other sensory information relating to the patient's wound site and to the surgery module, e.g., the positioning of the arms 24. The physician operates the input controls of the tele-controller 14, which generates control signals that are transmitted to the PAMI field unit 12 and used to control the surgery module 22. Thus, even seriously wounded patients can be remotely treated by distant, experienced medical personnel, within a short time period and without the need for transportation. In effect, according to the present invention, widely distributed medical resources (namely, the experience and skills of physicians and surgeons located all over the world) are reallocated by the PAMI system 10 and shifted where needed on a worldwide basis, and closer in time to injurious events.

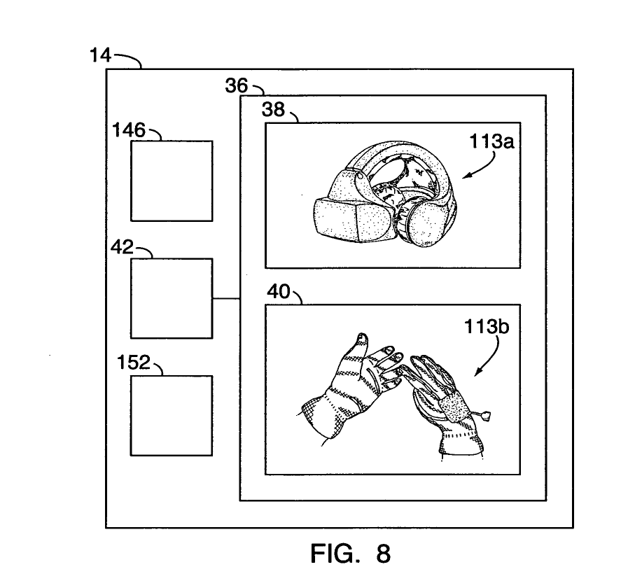

The portable, modular PAMI field unit 12 and the PAMI tele-controller 14, remotely connected to one another, are at the heart of the PAMI system 10. The relationship between these two components is in the nature of an augmented motor-sensory interface. This means that: (i) a physician 34 interacts with a user interface portion 36 of the tele-controller 14 (see FIG. 8), including receiving sensory input (audio/visual/tactile) from a multi-sense haptic “display” unit 38 and manipulating various real or virtual input controls 40; (ii) the physician's manipulations and/or movements are sensed and used by an electronic controller 42 (computer) to generate a set of control signals; and (iii) the control signals are transmitted over the communications link to the PAMI field unit 12, where the signals are used to control the surgery module 22. The control signals may need to be translated or converted for use by the surgery module 22, and these signals may be augmented or modified in a number of ways as described in prior patents and/or the applications noted below. For example, the control signals may be augmented for profiled microsurgery, wherein a certain amount of movement by the physician is converted into a control signal that causes the surgery module's arms 24 to move a proportionally and profiled smaller amount with custom motion parameter profiling modification. Another possible augmentation includes hand tremor scaling and modulation to improve surgeon performance. Further information about such augmented motor-sensory interfaces can be found in co-pending patent application Ser. Nos. 10/321,171 filed Dec. 17, 2002; Ser. No. 10/738,359 filed Dec. 17, 2003; and PCT/US03/40197 filed Dec. 17, 2003, which are hereby incorporated by reference in their entireties.

Referring to FIGS. 2-7, and as mentioned above, the PAMI field unit 12 includes the communications/control module 20 and the surgery module 22. The functions performed by these modules could be distributed among additional modules, as needed for portability, or incorporated into one module. The PAMI field unit 12 can be broken down or disassembled for stowage in one or more backpacks each weighing thirty pounds (30 lbs.) or less, or the entire unit might be less than 30 lbs. to fit into one backpack. This would allow the field unit 12 to be carried by any military unit for use in any location, even those only accessible by foot, such as heavily forested or rugged or mountainous areas. Larger versions of the PAMI field unit 12 could be configured for transportation by ground vehicle or helicopter, and it is contemplated that the PAMI field unit 12 could be permanently installed in a vehicle, e.g., ambulance, medical helicopter, ship/boat, or space vehicle.

The communications/control module 20 is configured to establish and maintain a communications link between the trauma network 16 and surgery module 22. It also provides and regulates electrical power, and serves as a control station for field personnel. As shown in FIGS. 2 and 7, the communications/control module 20 includes an internal CPU/computer unit 44 with associated memory 46, an internal fixed disc or other mass storage 48, and a local bus 50 providing a data connection between the CPU/computer 44 and other electronic components or subsystems. A user interface 52 includes one or more control/data input mechanisms 54 (keyboard, scanner, touch screen, microphone, pointer device, removable disc drives, etc.) and one or more data output mechanisms 56 (speaker, monitor/display, printer, removable disc drives, etc.). The user interface 52 allows a field medic 28 or other user to: communicate with other military units, a MEDEVAC, and the physician(s) 34, including entering vital statistics information and trauma reports; monitor the operational status of the PAMI field unit 12; perform diagnostics and calibration; and/or control other functionality as needed or required depending on the particular configuration of the PAMI field unit components.

The communications/control module 20 also includes an electrical power system 58, which may include: a primary internal power source 60 (battery, fuel cell, etc.); a secondary, backup internal power source 62 (additional battery, fuel cell, etc.); an external power source converter 64 configured for attachment to a number of different external power sources 66 (vehicle battery, solar panel array, wall outlet, generator, etc.); and a power regulator circuit 68. The regulator circuit 68 is configured to perform one or more of the following functions: conditioning all power sources to provide a steady and clean DC (typically) power waveform to all the PAMI field unit components; monitoring incoming power levels, and switching between the external power source, primary internal power source, and secondary internal power source, in that order of preference; automatically switching to an alternate power source upon detecting an interruption or reduction in the current power source; recharging the internal power sources 62, 64 if an adequate external power source 66 is present; and communicating with the CPU/computer 44 as to power status, e.g., sounding an alert when switching to an alternate power source.

An external communications system 70 also forms part of the communications/control module 20. The external communications system 70 may include a high-power, multi-band, wireless bidirectional transmitter 72, an optional backup or supplemental communications circuit 74 (e.g., a landline interface/modem, a cell phone interface or equivalent, and a backup transmitter), and one or more antennae and/or satellite dishes 76. Typically, the PAMI field unit 12 will send and receive wireless transmissions 78 as its primary communications mode, over a long distance to reach the communications link or relay 18. It is contemplated that the communications link 18 will comprise a communications satellite or satellite network 80 (e.g., various geostationary satellites over multiple areas, requiring a higher-power transmitter 72, or a LEO satellite network, requiring a lower-power transmitter 72) acting as a relay between the communications/control module 20 and a network-end, trauma control station 82 connected to the trauma network 16. Alternatively, instead of a satellite or satellite network, one or more ground-based transmission relay stations could be used to link the module 20 and trauma network 16, via wireless signals 78 and/or ground lines 84 or local electronic relay capabilities.

According to an alternative embodiment of the present invention, there may be a direct communication pathway between the trauma control station 82 and the communications/control module 20 portion of the PAMI field unit 12, provided the distance between the two is sufficiently short for the rated signal strength output of the PAMI field unit's transmitters 72, 74. This might be the case if the tele-controllers 14 are located at a forward base of operations, or if the trauma network 16, tele-controllers 14, medical doctors 34, etc. are all housed in a ship or other vessel stationed offshore from a combat area, or in a high-altitude aircraft flying far above, but within communications reach, of the combat area.

Referring back to FIG. 7, the communications/control module 20 could also include a vital statistics instrument interface 86. The instrument interface 86 would provide various input jacks or connectors for connecting various medical instruments to the communications/control module 20, as well as the electronic circuits required for operating the medical instruments and receiving medical information from them. Such medical instruments might include pulse oximeters, electronic sphygmomanometers, electronic stethoscopes, ECG/EKG/EEG electrodes, and the like. A patient's vital statistics information would be captured by the instruments and then automatically conveyed to the field medic 28 and/or physicians 34, e.g., the information might be displayed on the communications/control module's user interface 44 of the 20 and/or on the user interface portion 36 of the tele-controllers 14. The instrument interface 86 could instead be part of the surgery module 22 or the subject of its own module.

Additionally, the communications/control module 20 also has a surgery module I/O block or subsystem 88 for connecting the two modules 20, 22 together. The I/O block 88 may include: an output 90a for providing power to the surgery module 22; an input 90b for receiving video feeds or other signals from the video sensor boom 26; a second output 90c for routing control signals to the video sensor boom 26; third and fourth outputs 90d, 90e for routing control signals to the surgical effectors or arms 24; a second input 90f for receiving instrumentation signals back from the surgical effectors or arms 24; etc. (“Inputs” and “outputs” refer to any pathways or group of pathways suitable for conducting electrical signals, and not necessarily unidirectional.) The communications/control module 20 and surgery module 22 may be electrically connected via one or more cables or cable bundles 92. The cable bundle(s) 92 may take the form of a single cable bundle containing all the wires/cables needed to connect the two modules together, together with one or two multi-prong termination plugs for physically attaching the cable bundle to the modules. The cable bundle may be permanently connected to one module and with a plug for attachment to the other module, to reduce the chances of misplacing the cable bundle, or a dual-ended detachable cable may be used. Of course, the internal wires/cables in the cable bundle would have to be suitably insulated or sheathed to avoid signal crosstalk, interference, environmental inefficiencies and degradation, etc.

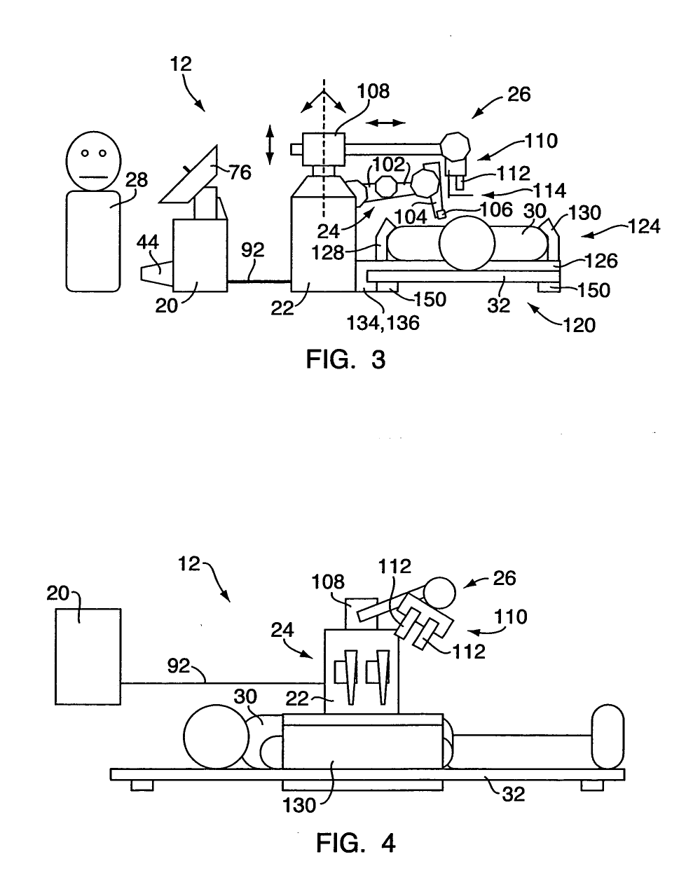

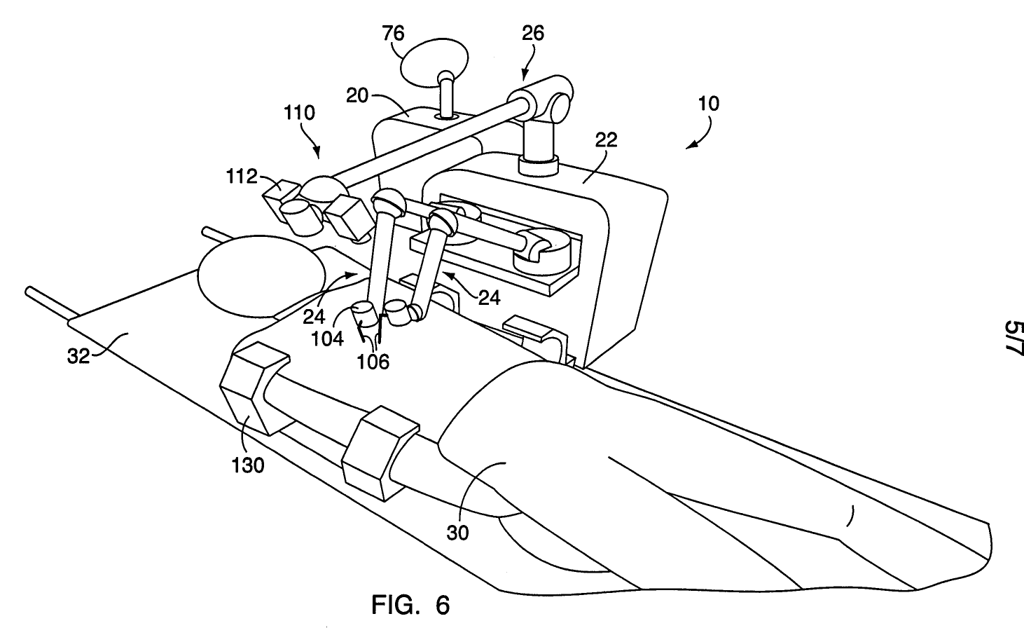

With reference to FIGS. 2-7 and 9, the surgery module 22 includes the video sensor boom 26, at least one bilateral surgical effector or arm 24, and various support circuitry including an I/O block or subsystem 100, similar to the I/O block 88 portion of the control/communications module 20, that routes power and control signals to the arms 24 and video sensor boom 26. Each surgical arm 24 is generally “robotic” and articulated in nature, and may include a plurality of moveable arm segments 102, a “hand” portion 104 to which surgical tools or instruments 106 can be attached, and an electric positioning and movement subsystem (e.g., a network of motors, sensors, cabling, and/or controllers) for very accurately moving and positioning the arm 24 and its subcomponents through up to seven degrees of freedom (“7 DOF”), as best seen in FIGS. 3 and 6. The arms 24 will typically be at least as maneuverable as a human arm/hand, but may also be capable of a much finer degree of movement and positioning for microsurgery.

The hand portion 104, as mentioned, can hold various surgical instruments 106, including scalpels, probes, forceps, cauterizers, scissors, staple guns, retractors, and endoscopes. The hand 104 may have an onboard module of interchangeable instruments, or the surgical instruments 106 may be attached to the hand portion 104 by the field medic 28 when so instructed by a physician 34. The hand portion 104 may also have a grasping unit that performs a similar function as the human hand or portion thereof. Since some of the surgical instruments 106 may require power and/or have onboard sensors, gauges, and detectors (e.g., temperature sensors, miniature video cameras, motion/contact sensors), the arms 24 have suitable internal wiring and connectors for electrically interfacing with the instruments 106, as needed.

The video sensor boom 26 provides a detailed view of a patient's wound area, just as if a physician was standing over the patient at an operating table. The video sensor boom 26 has a moveable, “robotic” boom-arm 108, which can be controlled (through a set of up/down, extend/retract, and pivot movements, as indicated by the directional arrows in FIG. 3) to accurately position a camera system 110 above a wound site. The camera system 110 may include at least two video cameras or sensors 112 arranged in a stereoscopic or binocular manner, but mono capability may serve based on situational requirements. The cameras 112 generate two video signals of the wound site which are separately stereoscopically displayed to the physician, i.e., the images captured by the left and right cameras are respectively displayed on screens in front of the physician's left and right eyes. This provides a sense of depth for the physician. Alternatively, a single camera and single image may be used. Additionally, the cameras may have zoom and microscope functions and IR/night vision capability, and they may be outfifted with lights (as may the arms 24) for use in low-light situations where several levels of stealth are respected.

In terms of tele-control functionality, one of the goals of the present invention is to translate the detailed actions of a surgeon/physician from one location to another, distant location, to the greatest extent possible, and in an extremely light and portable, easily deployed package. During surgical procedures, physicians usually experience some degree of touch and motion sense, which provides a measure of feedback that assists them, consciously or subconsciously, in performing the procedure accurately. Examples include a sense of contact when an instrument contacts or encounters tissue, a sense of resistance relative to the degree of difficulty in penetrating or cutting tissue, motion/sensory integration contours to improve surgical performance, and the like. This touch/motion feedback sense is incorporated in the PAMI system 10 by tele-haptics functionality. This means that motion and touch sense at the arms 24 (detected by electronic sensors in the arms 24) is transmitted back to the PAMI tele-controllers 14 and then translated for detection by the physician through the multi-sense display portion 38 of the tele-controller 14.

The following sequence of events illustrates the tele-haptics process. First, during an operation a surgical instrument 106 encounters bone and comes to a halt. Motion and/or contact sensors in the instrument 106 or hand portion 104 detect this occurrence and generate electrical signals representative of the occurrence. The signals pass through the arms 24 and are sent from the surgery module 22, through to the control/communications module 20, over the communications link 18, and to the PAMI tele-controller 14. Then, the multi-sense display portion 38 of the tele-controller 14 translates, modulates, modifies and profiles the signals to activate an improved but representative feedback profile of the occurrence. For example, a visual indicator may be activated, or a hand control 40 being operated by the physician may jolt or vibrate. An exact replication of the nature and character of the detected occurrence (at the surgical instrument end) is not needed, as long as the physician receives processed representative feedback and is appropriately trained to recognize the nature of the feedback, its significance, and degree.

As part of the user interface portion 36 of the PAMI tele-controller 14, “virtual reality”-type gear could be used, as indicated in FIG. 8. For example, a physician could wear a headset 113a having left and right screens for respective display to the physician's left and right eyes, motion sensors for detecting the physician's head movement and causing the camera system 110 to move correspondingly, and speakers near the physician's ears for outputting sound. Movement detection gloves 113b, worn by the physician, could also be used as controller inputs for detecting the physician's arm and hand movements and moving the surgical arms 24 similarly, and as a means for outputting tele-haptics feedback. (Prior AMI devices require 7 DOF universal surgical instrument handle controller interfaces.) The PAMI tele-controller 14 could also generate a virtual, “heads-up display” in the headset's screens that would show the patient's vital statistics and other information, and provide virtual “buttons” for selecting among different functions or modes.

Further information about the arms 24 and video sensor boom 26, including additional information on tele-haptics and haptic sensors and instruments, may be found in the above-mentioned co-pending patent applications, previously incorporated by reference.

As shown in FIG. 3, a removable, transparent splash screen 114 may be attached to the video sensor boom 26 in front of the cameras 112 to prevent bodily fluids or other liquids from splattering on the cameras 112. This is readily changeable by the medic or automatically by the unit as needed.

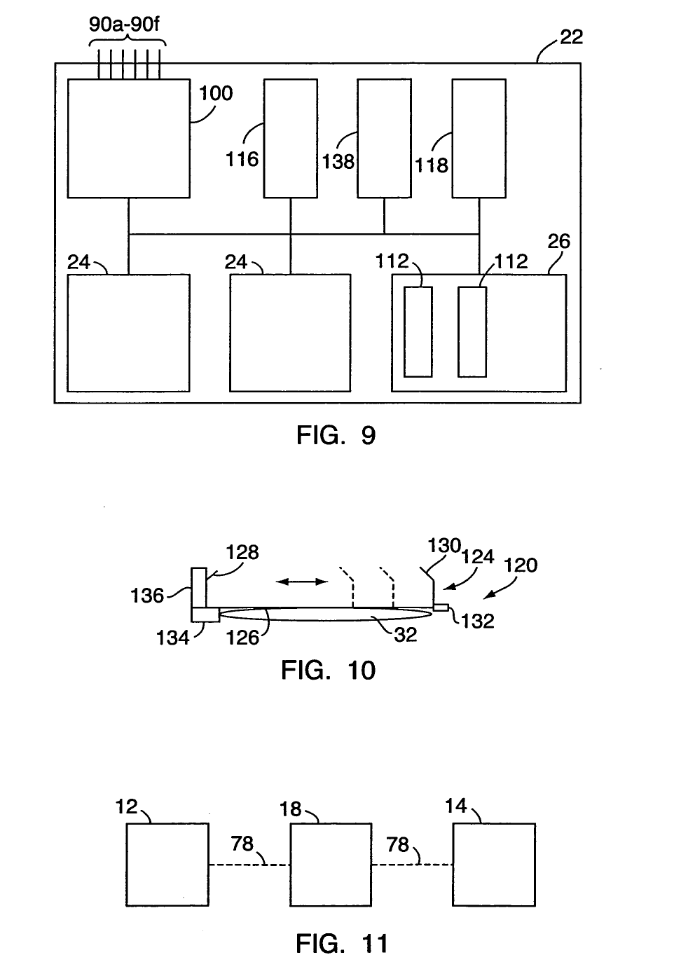

Reference back to FIG. 9, the surgery module 22 may have various supplemental surgical support or treatment mechanisms 116 for use by the field medic 28. These could include a suction apparatus, a wound flush/wash apparatus, a respirator, an endoscope, a defibrillator, and an imaging device (x-ray, ultrasound). The surgery module 22 may also have additional cameras 118 for providing different views of the environs or patient, e.g., a wide-angle camera for viewing the entire patient, and a “fish eye”-type camera showing the area around the PAMI field unit 12.

FIGS. 3-6, and 10 show an optional patient support system 120 that could be used as part of the PAMI system 10 to support and immobilize the patient 30 during surgical procedures and transport. In particular, a patient restraint mechanism 124 in the form of a scoop-like device, as particularly shown in FIGS. 3 and 10, is attached to the stretcher 32. The base of the restraint 124 is a flat support member 126, to which first and second arm cradles 128, 130 are attached. The support member 126 rests on top of the stretcher 32. The arm cradles are generally parallel to one another and can comfortably but securely hold a patient's arms and other body parts (legs). It can hold the patient in supine, prone, or lateral positions as needed. One or both of the arm cradles 130 are adjustable, at indicated by the directional arrow in FIG. 10, and are securable in place by a clamp or latch 132. (The support member 126 may have features, such as guide tracks and latch holes, that cooperate with the arm cradles 128, 130 and clamp/latch(es) 132.) The support system 120 may also include a stretcher clamp 134 or other means for attaching the support member 126 to the stretcher 32. Additionally, the support system 120 and surgery module 22 may have complementary features for attaching the support system 120 to the surgery module 22, e.g., a master clamp 136 on the support system 120 that mates with a clamp receptacle (not shown) on the side of the surgery module 22. Also, the support system 120 may have built-in active sensors for monitoring vital statistics or otherwise.

In operation, the patient support system 120 is first assembled by, e.g., attaching the connection member 126 and arm cradles 128, 130 to the stretcher 32, or as otherwise needed. Then the support system 120 is attached to the surgery module 22 so that the support system 120 is in front of the surgery module 22 by the arms 24 and video sensor boom 26. Subsequently, the patient 30 is positioned on the stretcher 32 with an arm against one arm cradle 128. Finally, the other arm cradle 130 is moved into place against the patient's other arm, and is locked in place using the clamp/latch 132. In this manner, the patient 30 is held stationary both in a general sense and with respect to the surgery module 22.

With the patient support system 120 attached to the surgery module 22, the patient 30 and PAMI field unit 12 may be transported together, if necessary, while surgical procedures are ongoing. For this purpose, the surgery module 22 may include a vibration compensation subsystem 138, as shown in FIG. 9. The vibration compensation system 138 would detect vibration or shock encountered during transportation and adjust the positioning, movement, and/or image or data signals of the arms 24 and video sensor boom 26 accordingly to minimize relative movement.

Other types of restraints may be provided in addition to or in place of the arm cradles 128, 130. Alternative restraints include simple adjustable straps and head and leg restraints. Additionally, the patient support system 120 could take many different, alternative forms. For example, the patient restraint mechanism 124 could be built into the stretcher 32 or attached to it to travel with it. It would in turn be attachable to the surgery module 22.

Referring back to FIG. 2, the trauma control station 82 and trauma network 16 provide a means for controllably distributing signals and other information from the portable PAMI field units 12 to the PAMI tele-controllers 14, and vice versa. The trauma control station 82 may include: a bidirectional communications transmitter 140 (including a satellite dish and/or antennae); a network controller 142 for maintaining and controlling the network 16, including governing bidirectional communications across the network; and a CPU/computer unit 144 that classifies and routes incoming and outgoing communications, as further discussed below. (The PAMI tele-controllers 14 will have network controllers 146 for interfacing with the network 16.) The trauma network 16 may be a wireless network, a cable-based network, or a combination of both, and may be a dedicated part of the PAMI system 10, a multi-use network, and/or an existing network such as the Internet. The PAMI system 10 may include encryption and security features for securing transmissions, as well as redundant or backup systems in case of primary system failure.

Furthermore, as illustrated in FIG. 2, a number of the portable PAMI field units 12 are positioned in the field at a number of different locations L1, L2. The locations L1, L2 could be in the same combat area, in different combat areas within the same theater of military operations, or in completely unrelated and distant locations anywhere in the world.

Typically, a military combat squad or unit will be given one or more PAMI field units 12 as part of its medical gear. The field units 12, as mentioned above, are modular and meant to be carried in backpacks. Thus, the unit's field medic 28 may carry all or a portion of the PAMI field unit(s) 12, with other personnel carrying other portions, if needed. Alternatively, the PAMI field unit(s) 12 may be carried in a vehicle, which can be dedicated (a built-in field unit) or not.

The PAMI system 10 includes a team of medical doctors 34, each of which has access to his or her own PAMI tele-controller 14. The trauma control station 82 and various physicians 34 may all be at the same location, or they may be at different locations L3, L4, L5, and L6, which may be very distant from the PAMI field units 12. For example, the different locations L3, L4, L5 and L6 may be in various parts of the world. At the same time, some of the PAMI field units 12 might be located at a first location L1 in the combat zone, with additional PAMI field units 12 being located several miles away at a second location L2 in the combat zone.

When a soldier or other person 30 is wounded, if a field medic 28 is not immediately present, a fellow soldier (safety buddy aide) will assess the situation, apply first aid, and call for the field medic 28. When the field medic 28 arrives (along with any others carrying portions of the PAMI field unit 12 if needed), the field medic will first administer further first aid to stabilize the patient 30, and then set up the PAMI field unit 12. This might include unpacking the modules 20, 22, attaching the communications/control module 20 to the surgery module 22, deploying or attaching the arms 24, video sensor boom 26, and antenna 74, powering up the components, setting up the patient support 120, and affixing sterile drapes.

Upon powering up, the communications/control module 20 may automatically “come online” by establishing a communications link to the trauma control station 82. The system may be configured so that the control station 82 assumes the presence of a wounded soldier 30 and automatically alerts the physicians 34, or it may reside in an initial “standby” mode until the field medic 28 confirms that a soldier has been wounded. In either case, once the physicians 34 are alerted, they proceed to their respective PAMI tele-controllers 14 as quickly as possible.

Once the PAMI field unit 12 is set up, the patient 30 is arranged on the patient support system 120 and immobilized in place. The patient 30 is positioned so that the wound is accessible by the arms 24 and within the range of the video sensor boom 26. The field medic 28 then takes the patient's vital statistics, either manually or through the vital statistics instrument interface 86, and inputs into the control/communications module 20 a brief report as to the cause and nature of the injury. This may be done via text entry or by voice/audio entry through a microphone. The vital statistics data, medic's report, an initial view of the wound site (captured by the cameras 112), etc. are transmitted to the trauma control station 82. The medic assists the PAMI field unit throughout the operative procedure including intermittent changes and operative field configuring as needed.

One aspect of the PAMI system 10 involves the possibility of several physicians viewing the same data from a single PAMI field unit 12, remotely conferring among themselves to establish a consensus diagnosis, and determining which among them is best qualified to perform the procedure in question (an “initial assessment”). Accordingly, since there may be multiple surgical units 12 in use, and since there are multiple physicians 34 and PAMI tele-controllers 14 at widely dispersed geographic sites, the trauma control station 82 will typically be configured to select, switch, assess, and/or route various incoming and outgoing signals to various selected PAMI field units 12 and PAMI tele-controllers 14, depending on available resources. For example, if only one PAMI field unit 12 is in use, the control station 82 will create a link between that PAMI field unit 12 and all the available PAMI tele-controllers 14. Once a physician 34 is appointed to perform a surgical operation, that physician's PAMI unit 14 is placed on “unavailable” status and the remaining PAMI tele-controllers 14 are cleared for alternate use and placed on standby. Similarly, if all the tele-controllers 14 are allocated for an initial assessment and another PAMI field unit 12 comes online, a portion of the tele-controllers 14 are reallocated and assigned to the new PAMI field unit 12. Any unavailable-status PAMI tele-controllers 14 (i.e., those in active use for surgery) are not reallocated. Also, the physicians 34 may have some input as to whether their PAMI tele-controllers 14 are reallocated at any particular time.

The PAMI system 10 may have the following additional features for allocating resources: if a new PAMI field unit 12 comes online when all the PAMI tele-controllers 14 are unavailable, a “wait” or “unavailable” signal is sent back to the PAMI field unit 12; priority may be given to severe wound types or to patients that are non-stable or in danger of dying; even when their PAMI units 14 are in unavailable status, physicians are able to inform the system that their patients have been stabilized and/or sufficiently treated so that an interruption, e.g., to handle a more serious case, would not prove life threatening; and the system may attempt to first route certain types of injuries to physicians that specialize in treating those types of injuries.

The trauma control station 82 may be entirely automatic, with resource allocation and switching decisions being made through algorithms in the CPU/computer unit portion 144 of the station 82, or decisions may be made entirely or in part by human personnel stationed at the control station 82.

When an PAMI field unit 12 comes online, the trauma control station 82 establishes a link between the PAMI field unit 12 and one or more PAMI tele-controllers 14, depending on available resources and the other factors discussed above. The physicians 34 assigned to those PAMI tele-controllers 14 are alerted (audio/visual alarms, a beeper or cell phone notification, etc.) and proceed to their respective units 14 as soon as possible. These units may be widely geographically dispersed even at the international or inter-continental level. Once at the units 14, the physicians take up positions at the user interface portions 36 of their tele-controllers 14, including donning any VR gear 113a, 113b. As soon as a physician is in place and ready, the initial patient data is displayed or otherwise communicated, e.g., the initial camera view is displayed along with vital statistics information, and the field medic's audio report is played back. Then, the physicians assess the situation by performing one or more of the following steps: conferring among themselves through two-way audio or text over the network 16; conferring with the field medic 28 through two-way audio or text over the communications link 18; having the field medic 28 conduct supplemental diagnostic tests or procedures (e.g., x-rays or ultrasound) and/or manipulate or expose the wound area; viewing the video feeds and vital statistics data; operating the controls of the user interfaces 36 to move the camera system 110 (to get different views) and the arms 24 (e.g., for probing the wound); and referencing computer-based medical literature available on the PAMI tele-controllers. The physicians 34 may take turns in controlling the surgery module 22 at this stage, if needed, or a single physician may be given priority of control at his respective geographic site.

Instead of potentially allocating multiple PAMI tele-controllers 14 to each PAMI field unit 12 as it comes online (and with a corresponding multiple-physician review/diagnosis), the PAMI system 10 may be instead configured to simply allocate one PAMI tele-controller 14 to each PAMI field unit 12. In such a case, a single physician 34 would handle initial review, diagnosis, and ongoing treatment/surgery. The physician could be given the option of having a different physician at a different PAMI tele-controller conduct the operation if he or she was unqualified to perform the necessary procedure(s).

Once a physician 34 is designated to perform the operation or medical procedure, the trauma control station 82 classifies that physician's PAMI unit 14 as being unavailable, and maintains a dedicated and ongoing link between that PAMI tele-controller 14 and the PAMI field unit 12 in question. Also, the designated physician 34 is given sole control over the surgery module 22. If other physicians are available, the signals/data being received from the PAMI field unit 12 may also be routed in parallel to their PAMI units 14, for them to act as consultants or backups. In that case, their user interface controls 40 would be deactivated until or unless the designated physician relinquishes control or is otherwise unable to continue with the procedure due to equipment failure, communication disruption, or otherwise.

To operate on a patient 30, the designated physician 34 manipulates or otherwise interacts with the user interface controls 40 according to his or her experience and training, and depending on the nature and character of the wound and information received back from the PAMI field unit 12 (e.g., video images, haptic feedback, and vital statistic data) and medic 28. These manipulations and interactions are sensed and used to generate corresponding control signals, which are transmitted to the PAMI field unit for controlling the surgery module 22, including moving and operating the arms 24 (arm segments 102 and hands 104), video sensor boom 26, and instruments 106. (As discussed above, the control signals may be translated and/or augmented by the trauma control station 82 or control/communications module 20.) Additionally, the designated physician bi-directionally communicates with the field medic 28, who may be instructed to supplement the surgery module's functionality or otherwise help with the medical procedure. For example, the field medic 28 may switch medical instruments, set retractors and clamps, suction the wound area, or the like. The field medic 28 continuously interacts with the PAMI field unit and the patient. The field medic then communicates and interacts with the physician 34.

When the medical procedure is completed, the designated physician may continue to monitor the patient if not needed elsewhere, or the physician may alert the trauma control station 82 that he or she is again available. If additional patients are waiting for treatment at a particular PAMI field unit 12, the field medic may so notify the physician, who stays connected to that unit, or the link may be reset to start the entire process over for the new patient (i.e., allocation of various PAMI tele-controllers 14 depending on availability, review and consensus, and physician designation).

As indicated in FIG. 2, more than one PAMI field unit 12 may be set up for treating the same patient at the same time. To facilitate this, the stretcher 32 may have side rails 150 (see FIG. 2A) allowing multiple PAMI field units 12 to be attached along either side of the stretcher.

Instead of having multiple PAMI field units 12 connected over a network to multiple PAMI tele-controllers 14, more simple or direct connection topologies could be used. For example, as shown in FIG. 11, a single PAMI field unit 12 and single PAMI tele-controller 14 could be configured for direct connection to one another over a communications link 18.

The PAMI field unit 12 may include GPS circuitry and radio transponders, for tracking and to assist in quick medical evacuations. Also, both modules 20, 22 and their subcomponents preferably have the following characteristics: as small and lightweight as possible for transportation in backpacks or in vehicles, e.g., each module is 30 lbs. or less; exterior housings made from lightweight but durable materials, e.g., a magnesium alloy, titanium, or polymer; meet military specifications for durability, wide operable temperature range, radiation hardening, etc.; insulated and sealed from shock, vibration, dust, water, etc.; where applicable, silent or low noise; ease of field assembly and maintenance; and all external components in close proximity to where a patient would be positioned have antimicrobial coatings or properties, and/or can be easily covered with disposable, sterile drapes, covers, or shields for facilitating rapid field prep and patient turnaround.

According to another aspect of the present invention, it is contemplated that the PAMI system 10 could include an instruction or teaching module 152 as part of the PAMI tele-controllers 14, trauma control station 82, and/or PAMI field units 12 (in FIG. 8, the teaching module 152 is shown as part of the tele-controllers 14). The teaching module 152 records the actions of a physician during a medical procedure carried out through the PAMI system 10, as well as the signals and data being received from the PAMI field unit 12. Later, a student can initiate a playback of the recorded surgery through the PAMI tele-controller 14, allowing the student to relive the experience. For a more rigorous training experience, the speed of the playback may be increased or otherwise adjusted. Additionally, it is contemplated that a student could watch a procedure as it happens through a parallel-connected tele-controller 14, that a virtual, computer-generated training program could be run through the tele-controllers 14, and that the PAMI system 10 and teaching module 152 could be used for case review, archiving purposes, and outcome Q/A tracking and review.

Although the present invention has been illustrated primarily for use in combat situations, where it would improve the processing and care of injured personnel, it could also be adapted for use in other military and non-military situations. For example, the PAMI field units 12 could be used at isolated duty locations for both emergency and non-emergency care, e.g., on islands, ships, military bases, and submarines. They could also be used at military or VA hospitals for surgical specialty augmentation, thereby allowing a specialist physician to perform a procedure from a distant location and without having to travel to the hospital.

Also, although the present invention has been illustrated for use in a military context, it could also be implemented for non-military use. For example, the surgical units could be used in remote towns or outposts where medical care is not readily available, or they could be carried in emergency service vehicles for use in situations where a patient cannot be quickly transported to a medical facility. Additionally, where the setup and support of the surgical unit 12 has been primarily illustrated as being performed by a field medic, it could instead be performed by any medical assistant, including field medics, EMTs, paramedics, doctors, surgeons, other medical personnel, and other persons generally, given sufficient training or instructions.

Although the surgery module 22 has been illustrated as having robotic-type arms for interacting with patients for carrying out medical procedures, any type of tele-operable manipulators could be used, without departing from the spirit and scope of the invention. Also, although the PAMI field units 12 and tele-controllers 14 could be positioned near each other, it is primarily contemplated that at least one pair of the PAMI field units and tele-controllers will be positioned at different, distant locations, where by “distant” it is meant that a physician located at the tele-controller could not safely travel to the PAMI field unit and patient, using conventional transportation means, within the Golden Hour and within enough time to stabilize the patient in person, due to geographic remoteness or inaccessibility and/or situational circumstances such as ongoing combat, other hostilities, or natural or other disaster.

Regardless of its particular configuration as implemented, or the context in which it is used (military combat vs. military non-combat vs. civilian), the PAMI system 10 would provide a number of benefits, as discussed above and as summarized as follows: enhanced life and limb saving capabilities; faster triage and return to duty cycles; non-disruptive to existing procedures, staffing, and medical facilities; avoids need for transporting patient by enabling tele-procedures at the scene; a reduction in medical care expenses by reducing the total care burden with earlier, more expert, more efficient, and more effective intervention; global trauma tele-network support from the initial event through to later, definitive care; and superior education and training.

Currently, there are no civilian or military equivalents to the present invention, which provides a unique scheme for enhanced medical accessibility in a light weight transportable package. In particular, through its network of remote field units and tele-controllers, the PAMI system shifts advanced medical care resources forward both temporally and geographically, i.e., medical care is made available in disperse, remote geographic regions, and closer in time to trauma events. This is done without utilizing or otherwise requiring on-site physicians or surgeons, while taking full advantage of the experience and skill of a plurality of remotely connected physicians/surgeons. As such, the PAMI system: reduces overall medical costs (care is delivered earlier, the care is more thorough and appropriate to the situation, and specialized medical personnel do not have to be on hand); while offering greater distributive potential (advanced medical care can be delivered to more people, in a non-sequential manner, and across a wide, unlimited area).

The present invention may be characterized as a method or process for delivering medical care services to a patient, comprising the following steps: transporting a portable surgical unit (the PAMI field unit 12) comprising: at least one manipulator 24 configured for use in a medical procedure; and at least one sensor 26 for generating an image signal of the patient 30; setting up the portable surgical unit next to the patient; establishing a communications link 18 between the portable surgical unit and a control unit (the PAMI tele-controller 14), wherein the control unit and portable surgical unit are configured for tele-operation of the portable surgical unit by the control unit over the communications link 18; transmitting the image signal from the portable surgical unit to the control unit over the communications link; controlling the surgical unit to cause the at least one manipulator to interact with the patient for performing a medical procedure; and assisting the portable surgical unit in performing the medical procedure; wherein: the control unit is positioned at a first location and the portable surgical unit is positioned at a second location distant from the first location; the step of controlling the control unit is performed by a physician viewing the image signal and positioned at the first location; and the step of assisting the portable surgical unit is performed by a medical assistant positioned at the second location and under the direction of the physician issuing instructions from the control unit to the portable surgical unit over the communications link.

As noted above, the present invention is applicable to other situations, besides medical care, where it is desired to translate and/or transmit the actions of a person at one location to a second, distant location for purposes of manipulating a physical object located at the remote location. For example, the PAMI system 10 could be appropriately configured for use in tele-control of manufacturing operations, or for defusing explosives or live ordnance, or the like.

Since certain changes may be made in the above described augmented motor-sensory interface system for surgery, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A field unit for manipulating an object comprising:
a communications module configured for communications with a distant location;
a manipulation module operably connected to the communications module and configured for manipulating the object based on control signals received by the communications module from the distant location; and
at least one sensor operably connected to the communications module and configured for capturing sensory data of the object for transmission by the communications module to the distant location.

2. The field unit of claim 1 further comprising:
a restraint system for fixing the object relative to at least the manipulation module.

3. The field unit of claim 1 wherein the manipulation module comprises at least one articulated effector and at least one instrument operably connected to the at least one articulated effector and configured for use in manipulating the object.

4. The field unit of claim 3 wherein the manipulation module comprises at least two articulated effectors each configured for substantially mimicking the operability of human arms and hands.

5. The field unit of claim 1 wherein the at least one sensor comprises at least one video sensor configured for capturing a stereoscopic view of the object as at least a portion of the sensory data.

6. The field unit of claim 5 wherein the at least one sensor further comprises at least one biometric sensor configured for capturing biometric data of the object as at least a portion of the sensory data.

7. The field unit of claim 1 wherein the manipulation module includes at least one tele-haptics sensor configured for sensing at least one characteristic of the field unit's manipulation of the object.

8. The field unit of claim 1 wherein the manipulation module is a surgery module configured for performing one or more medical procedures on a human patient based on the control signals.

9. The field unit of claim 1 wherein:
the manipulation module is a surgery module comprising at least two articulated effectors each configured for substantially mimicking the operability of human arms and hands for performing one or more medical procedures on a human patient based on the control signals, said surgery module including at least one tele-haptics sensor configured for sensing at least one characteristic of the surgery module's performance of the one or more medical procedures; and
the at least one sensor comprises at least one video sensor configured for capturing a stereoscopic view of the patient as at least a portion of the sensory data.

10. The field unit of claim 9 wherein the surgery module is configured for performing the one or more medical procedures based on control signals received by the communications module from a tele-controller unit positioned at the distant location, said control signals being based at least in part on manipulations of an input control system portion of the tele-controller by a medical doctor viewing the sensory data.

11. A tele-controller comprising:
a communications system configured for communications with a field unit at a distant location;
a display for displaying sensory data of an object proximate to the field unit and received by the communications system from the field unit; and
an input control system configured for generating control signals based at least in part on manual manipulations of the input control system in response to the sensory data displayed on the display, wherein the control signals are configured for control of the field unit to manipulate the object.

12. The tele-controller of claim 11 wherein at least one of the input control system and display is configured for generating tele-haptics feedback received by the communications system from the field unit.

13. The tele-controller of claim 11 wherein:
the display comprises a stereoscopic display; and
the input control system includes controller inputs configured for sensing the motions of a medical doctor in performing a medical procedure.

14. An object manipulation system comprising:
a field unit and a tele-controller configured for communicating over a distance with one another, wherein the field unit comprises:
a manipulation module configured for manipulating an object proximate to the field unit based on control signals received from the tele-controller; and
at least one sensor operably configured for capturing sensory data of the object for transmission to the tele-controller; and
wherein the tele-controller comprises:
a display for displaying the sensory data received from the field unit; and
an input control system configured for generating the control signals based at least in part on manual manipulations of the input control system in response to the sensory data displayed on the display, wherein the control signals are configured for control of the field unit to manipulate the object.

15. The system of claim 14 further comprising:
a plurality of said tele-controllers positioned at one or more first locations and interconnected by a network;
a router connected to the network; and
a plurality of said field units positioned at one or more second locations distant from the one of more first locations and configured for communicating with the network, wherein:
the router is configured for assigning respective tele-controllers to the field units when the field units contact the network, wherein the field units are configured to transmit sensory data to their respective tele-controllers of objects respectively located proximate to the field units; and
the tele-controllers are configured to transmit control signals to their respective field units, wherein the control signals are configured for control of the field units for manipulating their respective objects.

16. The field unit of claim 14 wherein:
the manipulation module is a surgery module comprising at least two articulated effectors each configured for substantially mimicking the operability of human arms and hands for performing one or more medical procedures on a human patient based on the control signals, said surgery module including at least one tele-haptics sensor configured for sensing at least one characteristic of the surgery module's performance of the one or more medical procedures; and
the at least one sensor comprises at least one video sensor configured for capturing a stereoscopic view of the patient as at least a portion of the sensory data.

17. The system of claim 16 further comprising:
a plurality of said tele-controllers positioned at one or more first locations and interconnected by a network;
a router connected to the network; and
a plurality of said field units positioned at one or more second locations distant from the one of more first locations and configured for communicating with the network, wherein:
the router is configured for assigning respective tele-controllers to the field units when the field units contact the network, wherein the field units are configured to transmit sensory data to their respective tele-controllers of objects respectively located proximate to the field units; and
the tele-controllers are configured to transmit control signals to their respective field units, wherein the control signals are configured for control of the field units for manipulating their respective objects.

18. An object manipulation system comprising:
a plurality of tele-controllers positioned at one or more first locations and interconnected by a network;
a router connected to the network; and
a plurality of field units positioned at one or more second locations distant from the one of more first locations and configured for communicating with the network, wherein:
the router is configured for assigning respective tele-controllers to the field units when the field units contact the network, wherein the field units are configured to transmit sensory data to their respective tele-controllers of objects respectively located proximate to the field units; and
the tele-controllers are configured to transmit control signals to their respective field units, wherein the control signals are configured for control of the field units for manipulating their respective objects.

19. A method of manipulating an object comprising the steps of:
transmitting sensory data of the object from a field unit to a tele-controller, wherein the field unit is positioned proximate to the object at a first location and is configured for controlled manipulation of the object, and wherein the tele-controller is positioned at a second location distant from the first location;
generating control signals based on manipulations of at least one input control of the tele-controller, wherein the manipulations are based at least in part on the sensory data;
transmitting the control signals to the field unit, wherein the control signals are configured for controlling the field unit; and
manipulating the object by the field unit based on the control signals.

20. The method of claim 19 further comprising the steps of:
displaying at least a portion of the object sensory data on a display of the tele-controller;
transmitting tele-haptics data to the tele-controller comprising at least one of motion data and touch data sensed by the field unit during manipulations of the object; and
generating feedback through at least one of the display and the at least one input control based on the tele-haptics data.
